(19) United States
(12) Patent Application Publication
(10) Pub. No.: US 2026/0336706 A1
(43) Pub. Date: Oct. 29, 2026

(54) VEHICLE-BODY REAR STRUCTURE

(71) Applicant: SUBARU CORPORATION, Tokyo (JP)

(72) Inventor: Yosuke HASEGAWA, Tokyo (JP)

(73) Assignee: SUBARU CORPORATION, Tokyo (JP)

(21) Appl. No.: 19/416,203

(22) Filed: Dec. 11, 2025

(30) Foreign Application Priority Data
Dec. 18, 2024 (JP) 2024-221999

(51) Int. Cl. B62D 21/15; B60R 5/04; B62D 21/02; B62D 25/08; B62D 25/20; B62D 25/24

(52) U.S. Cl. CPC B62D 21/152; B60R 5/04; B62D 21/02; B62D 25/087; B62D 25/2027; B62D 25/2036; B62D 25/24

(57) ABSTRACT

A vehicle-body rear structure includes left and right rear side frames, a rear floor pan, a first bending start point, a second bending start point, and a first bead. The rear side frames extend in a front-rear direction of a vehicle body. The rear floor pan is between the rear side frames and forms a sub trunk. The first bending start point is in an upper part of each rear side frame, and causes the rear side frames to bend with a collision load. The second bending start point is in a lower part of each rear side frame at a position forward of the first bending start point, and causes the rear side frames to bend with the collision load. The first bead is provided in the rear floor pan, and extends in a vehicle width direction of the vehicle body on a floor part of the sub trunk.

### CROSS-REFERENCE TO RELATED APPLICATIONS

The present application claims priority from Japanese Patent Application No. 2024-221999 filed on Dec. 18, 2024, the entire contents of which are hereby incorporated by reference.

### BACKGROUND OF THE INVENTION

### Field of the Invention

The disclosure relates to a vehicle-body rear structure including a sub trunk between rear side frames.

### Description of Background Art

Japanese Patent No. 5842747 describes a vehicle-body rear structure. The entire contents of this publication are incorporated herein by reference.

### SUMMARY OF THE INVENTION

According to one aspect of the present invention, a vehicle-body rear structure includes rear side frames that extends in a front-rear direction of a vehicle body at a rear part of the vehicle body, and a rear floor pan that is positioned between the rear side frames and forms a sub trunk recessed downward relative to the vehicle body. Each of the rear side frames has a first bending start point that is formed in an upper part of each of the rear side frames and causes a respective one of the rear side frames to bend with a collision load from a rear of the vehicle body, and a second bending start point that is formed in a lower part of each of the rear side frames at a position forward of the first bending start point and causes the respective one of the rear side frames to bend with the collision load, and the rear floor pan has a bead at a front-rear position of the vehicle body corresponding to the first bending start point such that the bead extends in a vehicle width direction of the vehicle body on a floor part of the sub trunk.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view of a rear part of a vehicle body as viewed from above a vehicle;

FIG. 2 is a side view of the rear part of the vehicle body as viewed from the left side;

FIG. 3 is a side view of a rear side frame as viewed from the left side;

FIG. 4 is a side view of a rear floor pan as viewed from the left side;

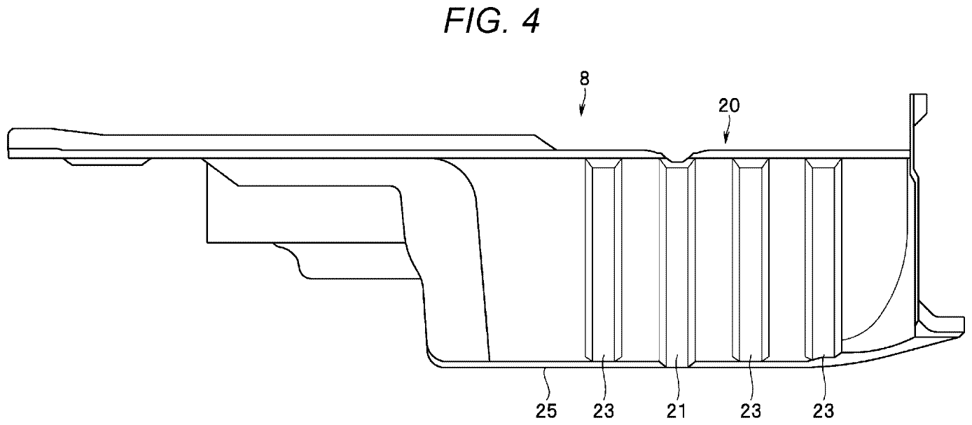

FIG. 5 is a side view of the rear part of the vehicle body at an initial stage during a rear collision, as viewed from the left side; and

FIG. 6 is a side view of the rear part of the vehicle body at a late stage during the rear collision, as viewed from the left side.

### DETAILED DESCRIPTION OF THE EMBODIMENTS

Embodiments will now be described with reference to the accompanying drawings, wherein like reference numerals designate corresponding or identical elements throughout the various drawings.

Factors including, without limitation, numerical values, shapes, materials, components, positions of the components, and how the components are coupled to each other are illustrative only and not to be construed as limiting to the disclosure.

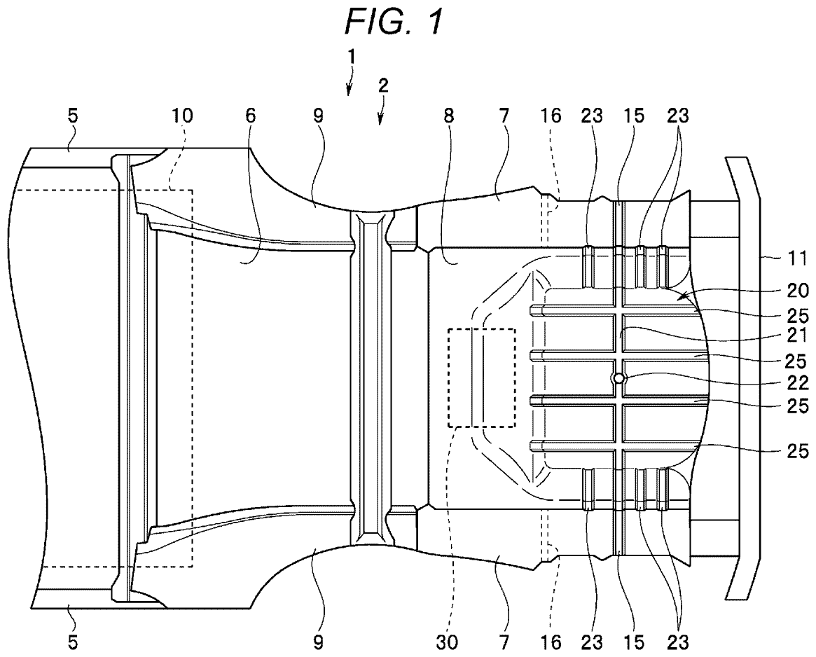

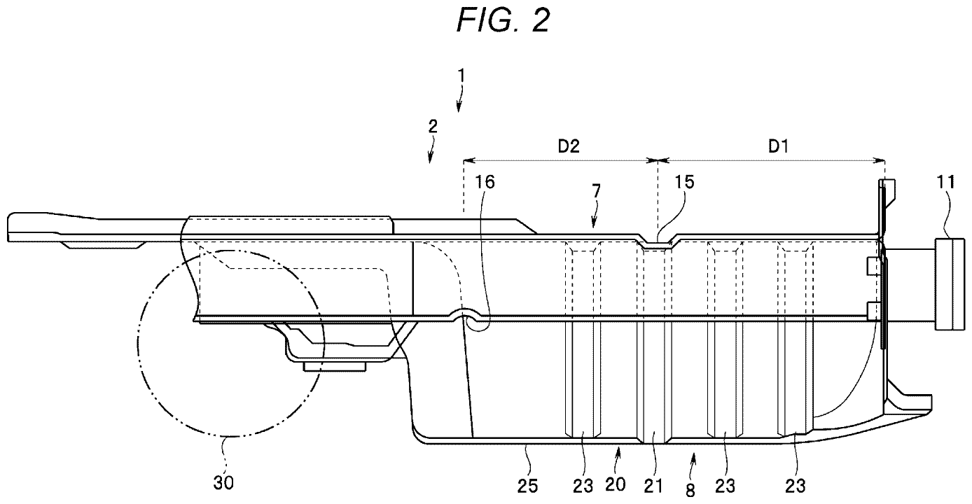

FIG. 1 is a plan view of a rear part of a vehicle body as viewed from above a vehicle. FIG. 2 is a side view of the rear part of the vehicle body as viewed from the left side.

A vehicle 1 illustrated in FIGS. 1 and 2 is, for example, an electric vehicle. A vehicle body 2 of the vehicle 1 includes side sills 5 disposed in a left and right pair, a center floor pan 6, rear side frames 7 disposed in a left and right pair, and a rear floor pan 8.

The left and right side sills 5 each have, for example, a rectangular hollow cross-sectional shape. The side sills 5 extend in a front-rear direction of the vehicle body 2 on both left and right sides of the vehicle body 2. To a rear end part of each of the side sills 5, a kick-up frame 9 is coupled.

The center floor pan 6 is provided between the left and right side sills 5 and the left and right kick-up frames 9. The center floor pan 6 has left and right side parts joined to the left and right side sills 5 and to the left and right kick-up frames 9 by welding or the like. Accordingly, the center floor pan 6 forms a floor part of a cabin of the vehicle body 2. In the underfloor space of the cabin below the center floor pan 6, a battery accommodating chamber 10 is formed. The battery accommodating chamber 10 accommodates battery cells (not illustrated).

The left and right rear side frames 7 each have, for example, a rectangular hollow cross-sectional shape. The rear side frames 7 extend in the front-rear direction of the vehicle body 2 at the rear part of the vehicle body 2.

A front end part of each of the rear side frames 7 is coupled to a corresponding one of the side sills 5 via a corresponding one of the kick-up frames 9. Rear end parts of the left and right rear side frames 7 are coupled by a rear bumper beam 11.

Each rear side frame 7 has a first bending start point 15 and a second bending start point 16. The first bending start point 15 and the second bending start point 16 are start points for bending the rear side frame 7 when a collision load is input from the rear of the vehicle body 2.

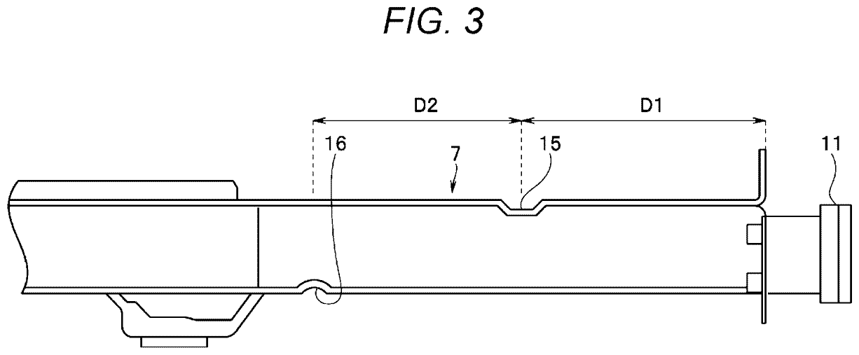

The first bending start point 15 is provided, for example, in an upper part of the rear side frame 7 at a position away forward from a rear end of the rear side frame 7 by a distance D1 (see FIG. 3). The first bending start point 15 is constituted by a bead extending in a vehicle width direction on the rear side frame 7. The bead constituting the first bending start point 15 is formed by, for example, a drawing process that causes a part of an upper wall of the rear side frame 7 to protrude downward.

Such a first bending start point 15 forms, in the upper part of the rear side frame 7, a weakened area with respect to a load in the front-rear direction of the vehicle body 2. Accordingly, when the collision load from the rear of the vehicle body 2 is input, the first bending start point 15 enables a part of the rear side frame 7 rearward of the first bending start point 15 to bend upward.

The second bending start point 16 is provided, for example, in a lower part of the rear side frame 7 at a position away forward from the first bending start point 15 by a distance D2. The second bending start point 16 is constituted by a bead extending in the vehicle width direction on the rear side frame 7. The bead constituting the second bending start point 16 is formed by, for example, a drawing process that causes a part of a lower wall of the rear side frame 7 to protrude upward.

Such a second bending start point 16 forms, in the lower part of the rear side frame 7, a weakened area with respect to a load in the front-rear direction of the vehicle body 2. Accordingly, when the collision load from the rear of the vehicle body 2 is input, the second bending start point 16 enables a part of the rear side frame 7 rearward of the second bending start point 16 to bend downward.

Here, the distance D1 and the distance D2 are preferably set to be substantially equal. In one example, the distance D1 is preferably set within a range of 95% to 105% of the distance D2.

The rear floor pan 8 is provided between the left and right rear side frames 7. The rear floor pan 8 has left and right side parts joined to the left and right rear side frames 7 by welding or the like. Accordingly, the rear floor pan 8 forms a floor part of a baggage compartment of the vehicle body 2.

In a rear part-side region of the rear floor pan 8, a recess that is recessed downward relative to the vehicle body 2 is formed. The recess forms a sub trunk (underfloor baggage compartment space) 20 in the baggage compartment of the vehicle body 2.

The rear floor pan 8 has a first bead 21 extending in the vehicle width direction on the floor part of the sub trunk 20. The first bead 21 is provided at a front-rear position of the vehicle body 2 corresponding to the first bending start point 15 of the rear side frame 7. Furthermore, the first bead 21 is preferably provided substantially at the center in the front-rear direction of the vehicle body 2 on the floor part of the sub trunk 20. FIG. 1 exemplifies the configuration in which the first bead 21 and the first bending start point 15 coincide with each other in the front-rear direction of the vehicle body 2, but the disclosure is not limited to such a configuration. For example, the first bead 21 and the first bending start point 15 may also be disposed in proximity to each other such that the distance therebetween in the front-rear direction of the vehicle body 2 is within a predetermined distance.

The first bead 21 has a shape protruding downward relative to the rear floor pan 8 on the floor part of the sub trunk 20. Thus, the first bead 21 viewed from the inside of the sub trunk 20 has a recessed groove shape. Such a first bead 21 is formed by, for example, a drawing process that causes a part of the rear floor pan 8 on the floor part of the sub trunk 20 to protrude downward.

On the floor part of the sub trunk 20, a drain hole 22 penetrating the rear floor pan 8 is provided at an intermediate part of the first bead 21.

Here, the first bead 21 extends to a side wall part of the sub trunk 20. In the side wall part of the sub trunk 20, the first bead 21 extends in an up-down direction of the vehicle body 2. Accordingly, the first bead 21 extends to a vicinity of the first bending start point 15.

In the present embodiment, the side wall part of the sub trunk 20 has, in addition to the first bead 21, beads 23 extending in the up-down direction of the vehicle body 2.

Furthermore, the rear floor pan 8 has second beads 25 extending in the front-rear direction of the vehicle body 2 on the floor part of the sub trunk 20. Each of the second beads 25 has a shape protruding downward relative to the rear floor pan 8 on the floor part of the sub trunk 20. Thus, each of the second beads 25 viewed from the inside of the sub trunk 20 has a recessed groove shape. Each second bead 25 is formed by, for example, a drawing process that causes a part of the rear floor pan 8 on the floor part of the sub trunk 20 to protrude downward.

Here, for example, as illustrated in FIG. 1, each second bead 25 intersects the first bead 21 at an intermediate part thereof.

Accordingly, on the floor part of the sub trunk 20, the recessed groove defined by the first bead 21 and the recessed groove defined by each second bead 25 are coupled to each other.

Furthermore, since the first bead 21 intersects the second beads 25, a part of the intermediate part of each second bead 25 is weakened, as compared with other parts, with respect to a load in the front-rear direction of the vehicle body 2.

In front of the sub trunk 20 with the above configuration, a motor 30 for driving rear wheels is disposed. Furthermore, around the motor 30, for example, a high-voltage component (not illustrated) for supplying driving power from a battery to the motor 30 is disposed.

According to the above-described embodiment, the vehicle-body rear structure includes the rear side frames 7 disposed in a left and right pair, and each extending in the front-rear direction of the vehicle body 2 at the rear part of the vehicle body 2, the rear floor pan 8 provided between the rear side frames 7, and forming the sub trunk 20 having a shape recessed downward relative to the vehicle body 2, the first bending start point 15 provided in the upper part of each of the rear side frames 7, and causing the rear side frame 7 to bend with the collision load from the rear of the vehicle body 2, the second bending start point 16 provided in the lower part of each of the rear side frames 7 at a position forward of the first bending start point 15, and causing the rear side frame 7 to bend with the collision load, and the first bead 21 formed in the rear floor pan 8 at the front-rear position of the vehicle body 2 corresponding to the first bending start point 15, and extending in the vehicle width direction of the vehicle body 2 on the floor part of the sub trunk 20. This structure can accurately absorb the collision load, and improve the functionality of the sub trunk 20.

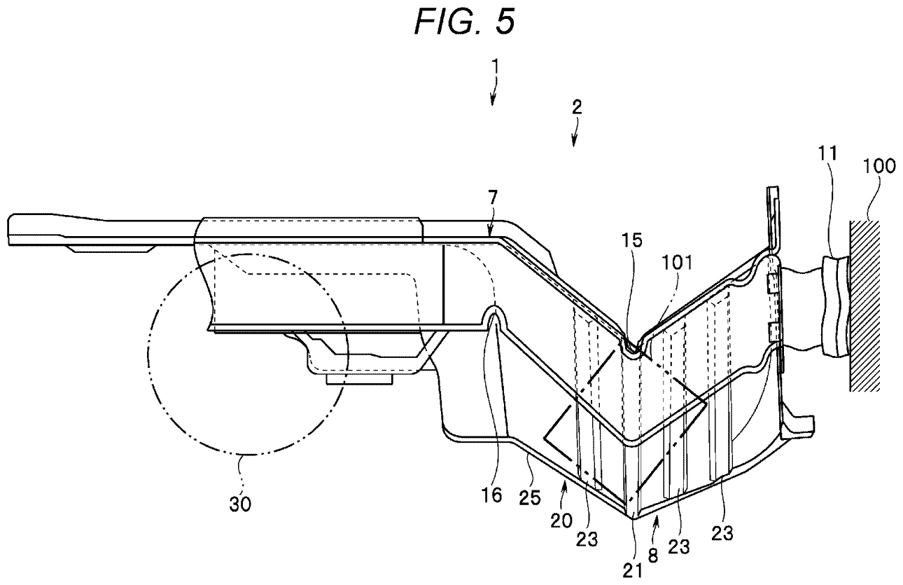

That is, when a barrier collision with the rear part of the vehicle body 2 occurs, a collision load is input to each of the rear side frames 7 via the rear bumper beam 11. When the collision load is equal to or greater than a predetermined value, each rear side frame 7 starts bending. As illustrated in FIG. 5, the bending direction of the rear side frame 7 is clearly defined by the first bending start point 15 disposed in the upper part of the rear side frame 7 and the second bending start point 16 disposed in the lower part of the rear side frame 7. Thus, even when a collision mode of a barrier 100 varies, the bending direction of the rear side frame 7 is controlled in a highly robust manner. This allows the rear side frame 7 to accurately absorb the collision load during a rear collision.

In this case, the distance D1 from the rear end of the rear side frame 7 to the first bending start point 15 is set to be substantially equal to the distance D2 from the first bending start point 15 to the second bending start point 16. Accordingly, in the rear side frame 7, substantially equal bending moments can be generated at the first bending start point 15 and the second bending start point 16. Accordingly, a large bending moment can be generated at the first bending start point 15 and the second bending start point 16, and the absorption efficiency of the collision load due to the bending of the rear side frame 7 can be enhanced.

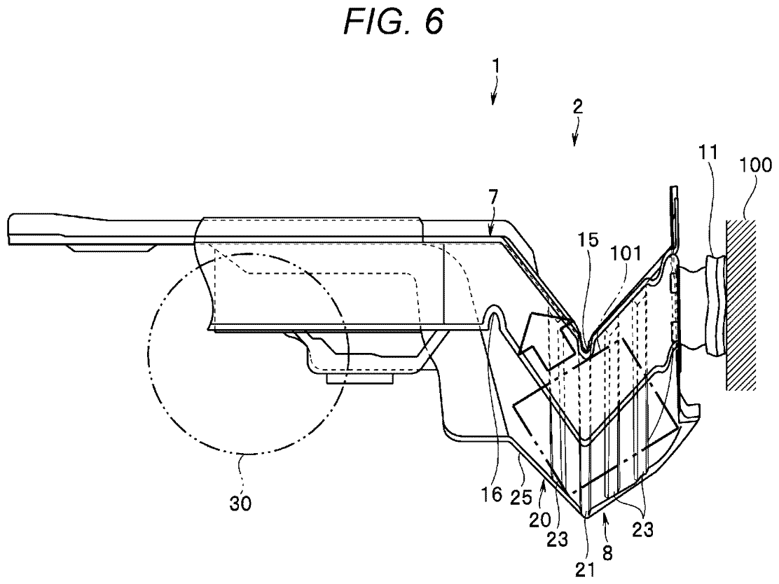

The rear floor pan 8 has the first bead 21 that is provided at the front-rear position of the vehicle body 2 corresponding to the first bending start point 15 and extends in the vehicle width direction on the floor part of the sub trunk 20. The first bead 21 causes the floor part of the sub trunk 20 to bend into a V shape in conjunction with the bending of the rear side frames 7 (see FIG. 5). By this bending, two front and rear inclined surfaces are formed on the floor part of the sub trunk 20. For example, as illustrated in FIG. 6, when the bending of the floor part progresses, baggage 101 loaded on the sub trunk 20 is pushed upward by the two inclined surfaces. In one example, the baggage 101 is pushed forward by the rear-side inclined surface of the floor part and slides upward along the front-side inclined surface of the floor part. Accordingly, even when the sub trunk 20 is crushed by the collision load, it is possible to prevent the baggage 101 from breaking through a front wall of the sub trunk 20 and moving toward the front of the vehicle body 2. Thus, even when the baggage 101 loaded on the sub trunk 20 is a rigid member, it is possible to improve a function for protecting electrical components such as the motor 30 and the like from the baggage 101 during a rear collision.

Furthermore, the first bead 21 formed on the floor part of the sub trunk 20 has a shape protruding downward relative to the rear floor pan 8. Additionally, the drain hole 22 penetrating the rear floor pan 8 is provided at the intermediate part of the first bead 21. With these configurations, the water having entered the sub trunk 20 is collected in the recessed groove defined by the first bead 21 and then discharged from the drain hole 22. Thus, the drainage function of the sub trunk 20 can be improved.

In this case, the second beads 25 extending in the front-rear direction of the vehicle body 2 are provided on the floor part of the sub trunk 20, and the second beads 25 intersect the first bead 21 at the intermediate parts thereof. Accordingly, the water in the sub trunk 20 can be more efficiently collected and discharged from the drain hole 22.

The disclosure described in the above-described embodiment is not limited to the embodiment, but various modifications may be made without departing from the scope of the disclosure in the implementation phase. Furthermore, the above-described embodiment includes disclosures at various stages, and the various disclosures can be extracted from the embodiment by appropriately combining constituent elements.

For example, even if some constituent elements are removed from all the constituent elements indicated in the embodiment, this configuration in which the constituent elements are removed can be extracted as the disclosure.

In vehicles such as automobiles, numerous vehicle-body rear structures for absorbing collision loads during rear collisions have been proposed. For example, Japanese Patent No. 5842747 discloses a vehicle-body rear structure including rear side members (rear side frames), a first weakened area provided in an upper part of each of the rear side members, and a second weakened area provided in a lower part of each rear side member and provided forward relative to the first weakened area. In such a technique, the left and right rear side frames bend from the first weakened area and the second weakened area during a rear collision, thereby absorbing collision loads.

In vehicles such as automobiles, a sub trunk may be formed between left and right rear side frames by a rear floor pan. Such a sub trunk can accommodate a jack or the like.

An aspect of the disclosure provides a vehicle-body rear structure. The vehicle-body rear structure includes rear side frames in a left and right pair, a rear floor pan, a first bending start point, a second bending start point, and a first bead. The rear side frames each extend in a front-rear direction of a vehicle body at a rear part of the vehicle body. The rear floor pan is provided between the rear side frames, and forms a sub trunk having a shape recessed downward relative to the vehicle body. The first bending start point is provided in an upper part of each of the rear side frames, and configured to cause the rear side frames to bend with a collision load from a rear of the vehicle body. The second bending start point is provided in a lower part of each of the rear side frames at a position forward of the first bending start point, and configured to cause the rear side frames to bend with the collision load. The first bead is provided in the rear floor pan at a front-rear position of the vehicle body corresponding to the first bending start point, and extends in a vehicle width direction of the vehicle body on a floor part of the sub trunk.

During the rear collision of the vehicle, the rear floor pan also deforms as the rear side frames bend. When the sub trunk is crushed due to the deformation of the rear floor pan, a rigid member such as a jack accommodated in the sub trunk may be pushed out into an underfloor space at a front part of the vehicle body.

In particular, in vehicles such as hybrid vehicles and electric vehicles, electrical components, such as a motor and a battery, installed in the underfloor space in front of the sub trunk may be damaged by the rigid member pushed out of the sub trunk.

It is desirable to provide a vehicle-body rear structure capable of accurately absorbing a collision load and improving the functionality of a sub trunk.

Obviously, numerous modifications and variations of the present invention are possible in light of the above teachings. It is therefore to be understood that within the scope of the appended claims, the invention may be practiced otherwise than as specifically described herein.

1. A vehicle-body rear structure, comprising:
a plurality of rear side frames configured to extend in a front-rear direction of a vehicle body at a rear part of the vehicle body; and
a rear floor pan positioned between the rear side frames and configured to form a sub trunk recessed downward relative to the vehicle body,
wherein each of the rear side frames has a first bending start point formed in an upper part of each of the rear side frames and configured to cause a respective one of the rear side frames to bend with a collision load from a rear of the vehicle body, and a second bending start point formed in a lower part of each of the rear side frames at a position forward of the first bending start point and configured to cause the respective one of the rear side frames to bend with the collision load, and the rear floor pan has a bead at a front-rear position of the vehicle body corresponding to the first bending start point such that the bead extends in a vehicle width direction of the vehicle body on a floor part of the sub trunk.

2. The vehicle-body rear structure according to claim 1, wherein a distance from a rear end of each of the rear side frames to the first bending start point is set within a range of 95% to 105% of a distance from the first bending start point to the second bending start point.

3. The vehicle-body rear structure according to claim 1, wherein the bead in the rear floor pan is protruding downward relative to the rear floor pan on the floor part, and the rear floor pan has a drain hole penetrating the rear floor pan at an intermediate part of the bead.

4. The vehicle-body rear structure according to claim 1, wherein the rear floor pan has a second bead extending in a front-rear direction of the vehicle body on the floor part of the sub trunk such that the second bead intersects the bead at an intermediate part of the second bead.

5. The vehicle-body rear structure according to claim 1, wherein the bead of the rear floor pan further extends in an up-down direction of the vehicle body in a left side wall part and a right side wall part of the sub trunk.

6. The vehicle-body rear structure according to claim 2, wherein the bead in the rear floor pan is protruding downward relative to the rear floor pan on the floor part, and the rear floor pan has a drain hole penetrating the rear floor pan at an intermediate part of the bead.

7. The vehicle-body rear structure according to claim 2, wherein the rear floor pan has a second bead extending in a front-rear direction of the vehicle body on the floor part of the sub trunk such that the second bead intersects the bead at an intermediate part of the second bead.

8. The vehicle-body rear structure according to claim 2, wherein the bead of the rear floor pan further extends in an up-down direction of the vehicle body in a left side wall part and a right side wall part of the sub trunk.

9. The vehicle-body rear structure according to claim 3, wherein the rear floor pan has a second bead extending in a front-rear direction of the vehicle body on the floor part of the sub trunk such that the second bead intersects the bead at an intermediate part of the second bead.

10. The vehicle-body rear structure according to claim 3, wherein the bead of the rear floor pan further extends in an up-down direction of the vehicle body in a left side wall part and a right side wall part of the sub trunk.

11. The vehicle-body rear structure according to claim 4, wherein the bead of the rear floor pan further extends in an up-down direction of the vehicle body in a left side wall part and a right side wall part of the sub trunk.

12. The vehicle-body rear structure according to claim 6, wherein the rear floor pan has a second bead extending in a front-rear direction of the vehicle body on the floor part of the sub trunk such that the second bead intersects the bead at an intermediate part of the second bead.

13. The vehicle-body rear structure according to claim 6, wherein the bead of the rear floor pan further extends in an up-down direction of the vehicle body in a left side wall part and a right side wall part of the sub trunk.

14. The vehicle-body rear structure according to claim 12, wherein the bead of the rear floor pan further extends in an up-down direction of the vehicle body in a left side wall part and a right side wall part of the sub trunk.
